(19) United States
(12) Patent Application Publication
(10) Pub. No.: US 2020/0236256 A1
(43) Pub. Date: Jul. 23, 2020

(54) CAMERA ASSEMBLY AND MOBILE DEVICE HAVING THE SAME

(71) Applicant: LUXVISIONS INNOVATION LIMITED, New Territories (HK)

(72) Inventors: Shih-Chieh Yen, New Territories (HK); Kuo-Hao Peng, New Territories (HK)

(73) Assignee: LUXVISIONS INNOVATION LIMITED, New Territories (HK)

(21) Appl. No.: 16/838,824

(22) Filed: Apr. 2, 2020

Related U.S. Application Data
(60) Provisional application No. 62/832,945, filed on Apr. 12, 2019.

(51) Int. Cl. H04N 5/225; G02B 7/02

(52) U.S. Cl. CPC H04N 5/2254; G02B 7/021; H04N 5/2253; H04N 5/2252

(57) ABSTRACT

A camera assembly and a mobile device having the same are provided. The camera assembly includes a housing and a lens assembly. The housing has an opening, and the lens assembly is disposed in the housing. The lens assembly includes a first lens and a second lens. The first lens is disposed adjacent to the opening and the first lens has a top lens portion. The top lens portion protrudes out of the opening. The second lens is disposed on a side of the first lens opposite to the top lens portion.

### CROSS-REFERENCE TO RELATED APPLICATION

This application claims the priority benefit of U.S. provisional application Ser. No. 62/832,945, filed on Apr. 12, 2019. The entirety of the above-mentioned patent applications are hereby incorporated by references herein and made a part of the specification.

### BACKGROUND

### Technical Field

The present disclosure relates to a camera assembly and a mobile device having the same.

### Related Art

Currently, many mobile devices are equipped with a camera (or a camera element) providing functions of photographing and video recording. Along with the technology development trend, mobile devices are usually equipped with not only a rear-facing camera, but also a front-facing camera. In order to obtain a better viewing and usage experience, the size and the range of the display screens of the mobile devices gradually increase. As a result, the bezel of the display screen is too narrow for the front-facing camera, and thus the front-facing camera of some mobile devices needs to be disposed at the inner side of the display screen.

### SUMMARY

In view of the above, the present disclosure provides a camera assembly that can be disposed at the inner side of a display screen and provides a mobile device having the same. According to one or some embodiments of the present disclosure, the camera assembly includes a housing, and a lens assembly. The housing has an opening, and the lens assembly is disposed in the housing. The lens assembly includes a first lens and a second lens. The first lens is disposed adjacent to the opening and has a top lens portion, and the top lens portion protrudes out of the opening. The second lens is disposed at a side of the first lens opposite to the top lens portion.

In at least one embodiment, a material of the first lens is glass, and a material of the second lens is plastic.

In at least one embodiment, the lens assembly further includes a third lens, and the second lens is located between the third lens and the first lens, and a material of the third lens is plastic.

In at least one embodiment, the lens assembly further includes a fourth lens, and the third lens is located between the fourth lens and the second lens, and a material of the fourth lens is plastic.

In at least one embodiment, the housing includes an upper housing and a lower housing. The top lens portion of the first lens outwardly protrudes from the upper housing, and a side surface of the top lens portion has a cover layer. The cover layer is a coating layer having an effect of light absorption, a coating layer having an effect of light extinction, or a coating layer having an effect of light absorption and light extinction.

In at least one embodiment, the camera assembly further includes an optical filter, an image-capturing element, and a circuit board. The optical filter is disposed at a side of the lens assembly opposite to the opening. The optical filter is located between the lens assembly and the image-capturing element, and the image-capturing element is configured to receive and to convert an optical image signal incident through the lens assembly into an electrical image signal. The circuit board is electrically connected to the image-capturing element.

A mobile device is provided and the mobile device includes a protective layer, a display element, and a camera assembly. The display element is adjacent to the protective layer, and the display element has a receiving trough. The camera assembly includes a housing and a lens assembly. The housing has an opening, and the lens assembly is disposed in the housing. The lens assembly includes a first lens, and a second lens. The first lens is disposed adjacent to the opening and has a top lens portion, and the top lens portion protrudes out of the opening and is accommodated in the receiving trough. The second lens is disposed at a side of the first lens opposite to the top lens portion.

In at least one embodiment, in the mobile device, a material of the first lens is glass and a material of the second lens is plastic.

In at least one embodiment, the lens assembly further includes a third lens, and the second lens is located between the third lens and the first lens, and a material of the third lens is plastic.

In at least one embodiment, the lens assembly further includes a fourth lens, and the third lens is located between the fourth lens and the second lens, and a material of the fourth lens is plastic.

In at least one embodiment, the housing includes an upper housing and a lower housing. The top lens portion of the first lens outwardly protrudes from the upper housing, and a side surface of the top lens portion has a cover layer. The cover layer is a coating layer having an effect of light absorption, a coating layer having an effect of light extinction, or a coating layer having an effect of light absorption and light extinction.

In at least one embodiment, the camera assembly further includes an optical filter, an image-capturing element, and a circuit board. The optical filter is disposed at a side of the lens assembly opposite to the opening. The optical filter is located between the lens assembly and the image-capturing element, and the image-capturing element is configured to receive and to convert an optical image signal incident through the lens assembly into an electrical image signal. The circuit board is electrically connected to the image-capturing element.

In view of above, the present disclosure provides a camera assembly that can be disposed at the inner side of a display screen and provides a mobile device having the same. By utilizing the camera assembly provided in one or some embodiments of the present disclosure, the internal space of the mobile device can be effectively utilized. Furthermore, by applying the camera assembly provided in one or some embodiments of the present disclosure to a mobile device, the overall thickness of the mobile device and/or the width of the bezel of the display screen may be reduced.

### BRIEF DESCRIPTION OF THE DRAWINGS

The disclosure will become more fully understood from the detailed description given herein below for illustration only, and thus not limitative of the disclosure, wherein:

FIG. 1 illustrates a cross-sectional view of a mobile device according to some embodiments of the present disclosure;

FIG. 2A illustrates a partial cross-sectional view of a mobile device according to some embodiments of the present disclosure;

FIG. 2B illustrates a partial cross-sectional view of a mobile device according to some other embodiments of the present disclosure;

FIG. 2C illustrates a partial cross-sectional view of a mobile device according to some other embodiments of the present disclosure;

FIG. 3 illustrates a perspective view of a camera assembly according to some embodiments of the present disclosure;

FIG. 4 illustrates a cross-sectional view of a camera assembly according to some embodiments of the present disclosure;

FIG. 5 illustrates a perspective view of a light shielding sheet according to some embodiments of the present disclosure;

FIG. 6 illustrates a partial cross-sectional view of a mobile device according to some embodiments of the present disclosure;

FIG. 7 illustrates a partial cross-sectional view of a mobile device according to some embodiments of the present disclosure;

FIG. 8 illustrates a cross-sectional view of a camera assembly according to some embodiments of the present disclosure; and

FIG. 9 illustrates a cross-sectional view of a camera assembly according to some embodiments of the present disclosure.

### DETAILED DESCRIPTION

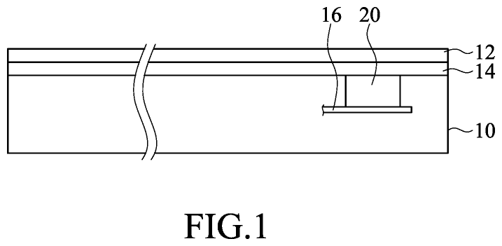

According to some embodiments of the present disclosure, the present disclosure provides a camera assembly, which can be applied to a mobile device. In some embodiments, the structure of a mobile device 10 can be referred to FIG. 1. The mobile device 10 may be, for example, but not limited to, a mobile phone, a tablet, or a notebook computer, and the mobile device 10 may have a photographing and/or video recording function. In some embodiments, the mobile device 10 includes a protective layer 12, a display element 14, a camera assembly 20, and a circuit board 16. The display element 14 may be, for example, but not limited to, a liquid crystal display (LCD), an organic light-emitting diode (OLED) display, a micro LED display, a mini LED display, or other light emitting display devices. The protective layer 12 is located at the outside of the display element 14 and may serve as a part of a casing of the mobile device 10 in some embodiments. The protective layer 12 may be used to protect the display element 14. Moreover, in some embodiments, the protective layer 12 is light-transmissible. That is, at least part of the light emitted by the display element 14 may penetrate through the protective layer 12. A user can view the content displayed by the display element 14 through the protective layer 12. In some embodiments, the protective layer 12 is a glass film.

In some embodiments, the circuit board 16 is electrically connected to the camera assembly 20 so as to transmit controlling signals, image signals, or the like. In some embodiments, the circuit board 16 and the camera assembly 20 may also be in physical contact with each other. The circuit board 16 may be a rigid flexible printed circuit board (RFPC), a normal printed circuit board (PCB), or a flexible PCB, but not limited thereto.

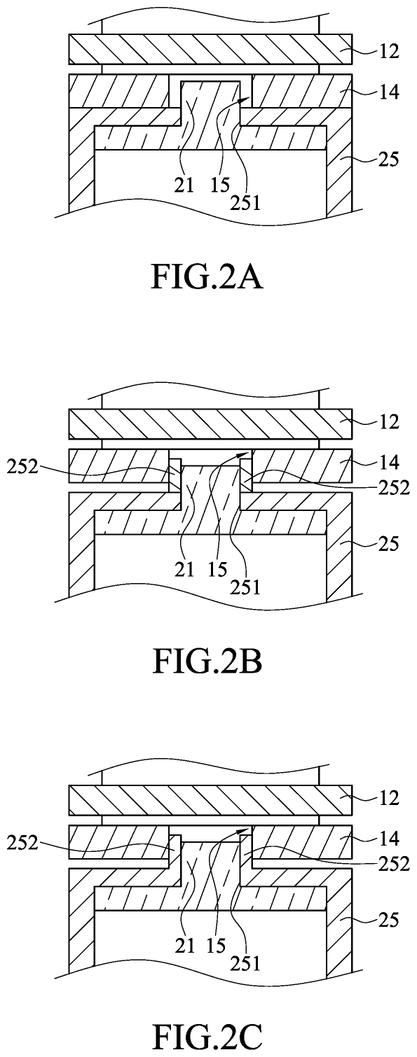

The camera assembly 20 is disposed in the mobile device 10. In some embodiments, as shown in FIG. 1, the camera assembly 20 is located at the inner side of the display element 14. In some embodiments, as shown in FIGS. 2A to 2C, a portion of the camera assembly 20 is accommodated in the display element 14.

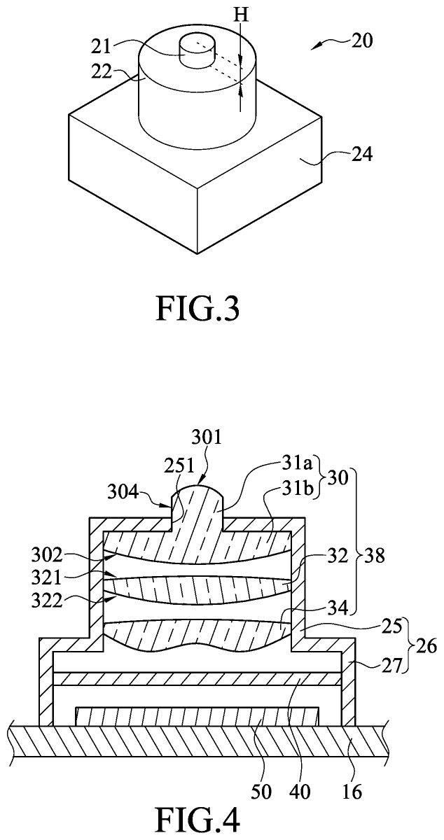

In the embodiments shown in FIG. 2A, the camera assembly 20 has a protrusion portion 21 protruding out from a housing 25 of a lens assembly 22 in the camera assembly 20 (the position of the lens assembly 22 may be referred to FIG. 3). The display element 14 has a receiving trough 15. The receiving trough 15 may be a perforation, and the protrusion portion 21 is in the receiving trough 15. For example, the housing 25 has an opening 251 aligned to the perforation, and the protrusion portion 21 protrudes out of the opening 251 and extends into the receiving trough 15.

In some other embodiments, as shown in FIG. 2B, the protrusion portion 21 may have an outer cover 252 surrounding the opening 251, and the outer cover 252 may be used to shield undesired ambient lights from entering into the camera assembly 20 or may be served as a protective structure of the protrusion portion 21. As shown in FIG. 2B, the outer cover 252 and the housing 25 may be two separated members, and the outer cover 252 may be connected to the periphery of the opening 251 of the housing 25. Alternatively, as shown in FIG. 2C, the outer cover 252 and the housing 25 may be a single-piece member; that is, the outer cover 252 may be a portion extended integrally from the periphery of the opening 251 of the housing 25. The top surface of the outer cover 252 may be lower than the top surface of the protrusion portion 21. Alternatively, as shown in FIG. 2B, the top surface of the outer cover 252 may be higher than the top surface of the protrusion portion 21. The term “the protrusion portion 21 protruding out of a housing 25 of the camera assembly 20” may refer to “in a side view, at least a part of the top surface of the protrusion portion 21 being higher than the upper surface of the housing 25”. Wherein the term “the upper surface of the housing 25” may refer to “a plane of the housing 25 having the largest area that is perpendicular to the extending direction of the protrusion portion 21”.

In some embodiments, the camera assembly 20 is located at the inner side of the protective layer 12. In some embodiments, a portion of the camera assembly 20 is accommodated in the protective layer 12. In some embodiments, the camera assembly 20 is a prime lens assembly, and the focal length of the prime lens assembly is a fixed value.

In some embodiments, the camera assembly 20 may be applied to a miniaturized mobile device 10. Although the space provided by the miniaturized mobile device 10 to accommodate the camera assembly 20 is limited, the camera assembly structure provided in one or some embodiments of the present disclosure can effectively utilize the internal space of the mobile device. Moreover, by applying the camera assembly structure to the mobile device, the overall thickness of the mobile device and/or the width of the screen bezel can be further reduced. In some embodiments, the overall height of the camera assembly 20 is less than 6 millimeters (mm) (in the embodiments shown in FIG. 3, the overall height is the distance from the top surface of the protrusion portion 21 to the bottom surface of the base 24), and thus can be applied to miniaturized mobile devices.

Please refer to FIG. 3. In some embodiments, the camera assembly 20 includes a lens assembly 22 and a base body 24. The camera assembly 20 is used for capturing images, and the captured images may be photos or videos. In some embodiments, as shown in FIG. 4, a housing 25 of the lens assembly 22 (may be also referred to as “an upper housing”) and a housing 27 of the base body 24 (may be also referred to as “a lower housing”) are a single-piece housing 26. In some embodiments, the housing 25 of the lens assembly 22 and the base body 24 are of a two-piece form. For instance, the housing 25 of the lens assembly 22 is embedded in the housing 27 of the base body 24. In the embodiments shown in FIG. 4, the lens assembly 22 includes the upper housing 25 and a lens assembly 38. The top lens portion 31a in FIG. 4 may correspond to the protrusion portion 21 in FIG. 3. The base body 24 in FIG. 3 may correspond to the lower housing 27, where the lower housing 27 may include an optical filter 40 and an image-capturing element 50.

In some embodiments, the image-capturing element 50 is located on the circuit board 16 and is used to convert the optical image signal incident on the image-capturing element 50 into an electrical image signal. The optical image signal comes from outside of the mobile device 10, passes through the protective layer 12, the display element 14, and the camera assembly 20, and arrives at an active area (that is, an area for optical sensing) of the image-capturing element 50. In some embodiments, the image-capturing element 50 is a complementary metal-oxide semiconductor (CMOS) active pixel sensor or a charged coupled device.

In some embodiments, the optical filter 40 (also referred to as an optics filter) is located on the image-capturing element 50 and is spaced from the image-capturing element 50 by a proper distance. In some embodiments, the optical filter 40 is fixed to the lower housing 27 so as to keep a proper distance from the image-capturing element 50. The optical filter 40 is used to filter an optical image signal incident from the lens assembly 22. In some embodiments, the optical filter 40 is used to allow visible lights to transmit therethrough and to block invisible lights. The wavelength range of the aforementioned visible lights is generally 400-700 nanometers (nm), which means that light having a wavelength within 400-700 nm can pass through the optical filter 40 and light having a wavelength not in the range of 400-700 nm will be blocked. In some embodiments, the optical filter 40 can allow visible lights and partial infrared rays to pass therethrough. In some embodiments, the optical filter 40 allows only infrared rays to pass therethrough. The optical filter 40 is disposed correspondingly to the image-capturing element 50, and can at least cover the active area of the image-capturing element 50.

Please still refer to FIG. 4. In some embodiments shown in FIG. 4, the housing 26 includes the upper housing 25 and the lower housing 27. The upper housing 25 is used to accommodate the lens assembly 38. In this embodiment, the lens assembly 38 is a three-piece lens assembly. The lens assembly 38 includes a first lens 30, a second lens 32, and a third lens 34. In some embodiments, the lens assembly 38 may be a four-piece lens assembly or a five-piece lens assembly. Each lens 30, 32, and 34 of the lens assembly 38 has two surfaces opposite to each other, which are the first surface and the second surface, respectively. Generally, the surface closer to the scene (that is, closer to the top of FIG. 4) is the first surface, and the other surface (that is, near the image-capturing element 50) is the second surface. For example, the first lens 30 has a first surface 301 (lens 1, surface 1) and a second surface 302 (lens 1, surface 2), the second lens 32 has a first surface 321 (lens 2, surface 1) and a second surface 322 (lens 2, surface 2), and so on. The first lens 30 is disposed adjacent to an opening 251 of the upper housing 25, and the second lens 32 is disposed on the side of the second surface 302 of the first lens 30. The third lens 34 is disposed on the side of the second surface 322 of the second lens 32. The material of each lens 30, 32, 34 of the lens assembly 38 may be, but is not limited to, glass or plastic. In some embodiments, the first lens 30 is a glass lens, and the remaining lenses 32 and 34 are plastic, referred to as 1G2P (1 glass, 2 plastic) for short. In some embodiments, the first lens 30 of the four-piece lens assembly is a glass lens, and the remaining lenses are plastic lenses, which are referred to as 1G3P (1 glass, 3 plastic) for short.

In the embodiment of FIG. 4, the first lens 30 is a stepped lens. The stepped first lens 30 includes a top lens portion 31a and a bottom lens portion 31b. The first surface 301 of the first lens 30 is located on the top lens portion 31a, and the second surface 302 of the first lens 30 is located on the bottom lens portion 31b. The side of the upper housing 25 away from the lower housing 27 has the opening 251, and the top lens portion 31a protrudes from the opening 251 of the upper housing 25 to form the aforementioned protrusion portion 21. In some embodiments, the opening 251 is substantially coplanar with the upper surface of the upper housing 25.

In some embodiments, the stepped first lens 30 is manufactured by a molding method, and the molded lens blank is grinded to obtain the first lens 30. The aforementioned grinding is, for example, but not limited to, processed by a rounding machine.

In some implementations, the top lens portion 31a of the first lens 30 protrudes outwardly from the upper housing 25, and there is a cover layer covering the side surface 304 of the top lens portion 31a. The cover layer may be a coating layer or a film formed by a coating method or by a spraying method. The cover layer has the effect of light absorption and/or light extinction (in other words, the cover layer may be a layer having an effect of light absorption, a layer having an effect of light extinction, or a layer having an effect of light absorption and light extinction), and can be black or other opaque colors. The material of the cover layer may be, for example, but not limited to, a screen printing ink. The cover layer is used to prevent light from entering into the first lens 30 from the side surface 304 of the top lens portion 31a, which may affect the image-capturing quality of the image-capturing element 50. In the embodiments of FIG. 2B or FIG. 2C, since the outer cover 252 covers the side surface 304 of the top lens portion 31a (the side surface 304 may correspond to the side surface of the protrusion portion 21), the side surface 304 of the top lens portion 31a may not have the cover layer.

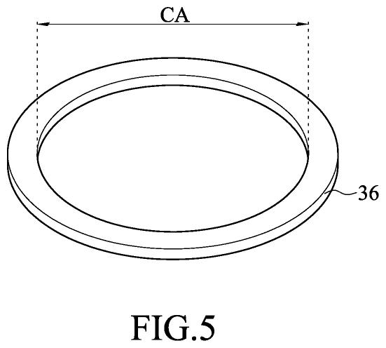

Please refer to FIG. 5. FIG. 5 illustrates a schematic perspective view of a light shielding sheet according to some embodiments of the present disclosure. In some embodiments, the first surface 301 of the first lens 30 is covered with a light shielding sheet 36. The outer diameter of the light shielding sheet 36 is substantially the same as the diameter of the first surface 301, that is, approximately equal to the diameter of the opening 251 of the upper housing 25. The light shielding sheet 36 has a perforation CA (clear aperture), which may define the effective area of the camera assembly 20. The light shielding sheet 36 may also be referred to as an aperture sheet. In this embodiment, the configuration in which the light shielding sheet 36 is placed on the first surface 301 of the first lens 30 is referred to as “front placed aperture”. Therefore, the light of the scene or objects passes through the perforation CA, the lens assembly 38, and the optical filter 40, and is received by the image-capturing element 50. The image-capturing element 50 converts the received optical image signal into an electrical image signal.

In some embodiments, the light shielding sheet 36 may be placed between the first lens 30 and the second lens 32. In other words, the light shield sheet 36 is located between the second surface 302 of the first lens 30 and the first surface 321 of the second lens 32. This configuration is referred to “middle placed aperture”. Therefore, in the foregoing embodiments with two position arrangements of the light shielding sheet 36, the outer diameter and the size of the perforation of the light shielding sheet 36 in the front placed aperture configuration may be different from that of the light shielding sheet 36 in the middle placed aperture configuration. For example, when the light shield sheet 36 is disposed in the middle placed aperture configuration, the outer diameter of the light shield sheet 36 may be substantially equal to the diameter of the upper housing 25, and the diameter of the perforation of the light shield sheet 36 may be at least greater than the diameter of the opening 251 of the upper housing 25.

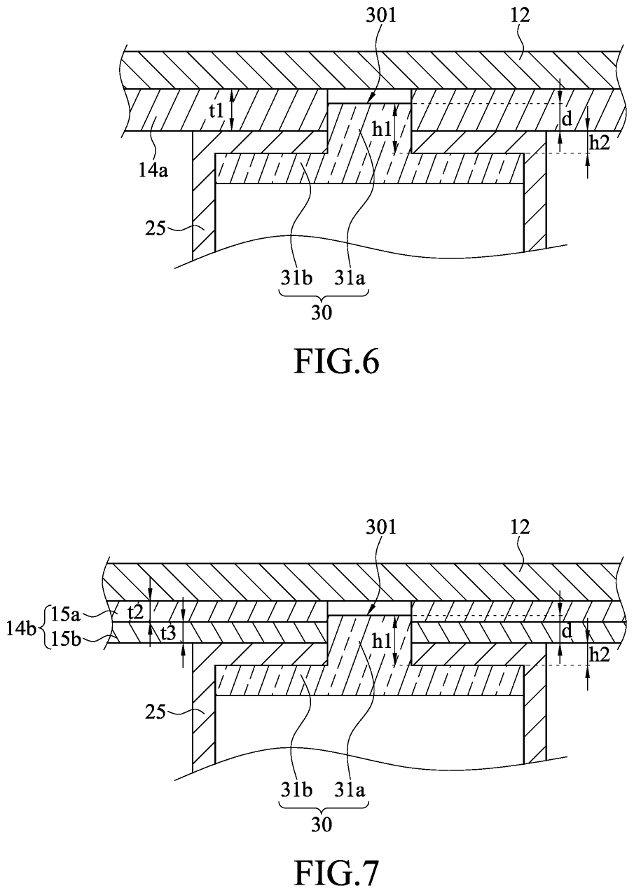

Next, please refer to FIG. 6. FIG. 6 illustrates embodiments that a portion of the first lens 30 is disposed in the display element 14, and the display element 14 is an organic light-emitting diode display (OLED display) 14a. The top lens portion 31a of the first lens 30 is accommodated in the receiving trough of the OLED display 14a. The first surface 301 of the top lens portion 31a may be separated from the protective layer 12, or the first surface 301 of the top lens portion 31a may be slightly in contact with the protective layer 12. That is, the difference d between the thickness h1 of the top lens portion 31a and the thickness h2 of the upper housing 25 is smaller than or substantially equal to the thickness t1 of the OLED display 14a.

Please refer to FIG. 7. FIG. 7 illustrates embodiments that a portion of the first lens 30 is disposed in the display element 14, and the display element 14 is a liquid crystal display 14b. The liquid crystal display 14b includes a liquid crystal layer 15a and a backlight layer 15b. The liquid crystal layer 15a and the backlight layer 15b have a receiving trough corresponding to the top lens portion 31a of the first lens 30. The thickness of the liquid crystal layer 15a is t2, and the thickness of the backlight layer 15b is t3. The top lens portion 31a is accommodated in the receiving trough of the liquid crystal display 14b. In some embodiments, the top lens portion 31a of the first lens 30 may be in the liquid crystal layer 15a or the backlight layer 15b. The first surface 301 of the top lens portion 31a may be separated from the protective layer 12, or the first surface 301 of the top lens portion 31a may be slightly in contact with the protective layer 12. That is, the difference d between the thickness h1 of the top lens portion 31a and the thickness h2 of the upper housing 25 is smaller than or substantially equal to the summation of the thickness t2 of the liquid crystal layer 15a and the thickness t3 of the backlight layer 15b (d≤(t2+t3)).

In some embodiments, the thickness h1 of the top lens portion 31a is about 0.5 to 1 mm. In some embodiments, the thickness h1 of the top lens portion 31a is about 0.2 to 2 mm. It can be adjusted depending on the optical design, the overall volume, and the design of the camera assembly 20.

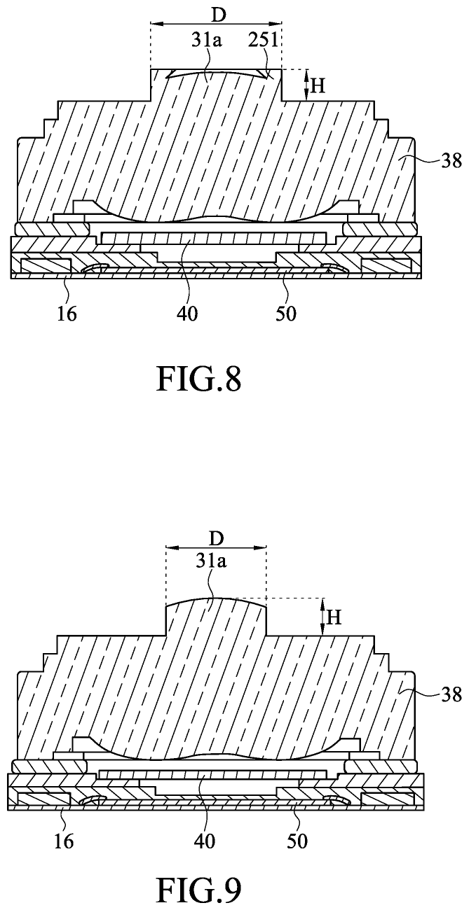

In some embodiments, the structure of the camera assembly 20 and the circuit board 16 is shown in FIG. 8. FIG. 8 may also be regarded as a cross-sectional view showing the lens assembly 38, the optical filter 40, the image-capturing element 50, and the circuit board 16 according to some embodiments. In the embodiments shown in FIG. 8, the outer cover 252 of the upper housing 25 covers the side surface 304 of the top lens portion 31a (which equivalents to the embodiments as shown in FIG. 2B or FIG. 2C). In the embodiments shown in FIG. 8, the D value (the diameter of the portion protruding out of the upper surface of the housing 25; in FIG. 2B or FIG. 2C, it refers to the diameter of the top lens portion 31a plus the thickness of the upper housing 25) is about 2.2 mm. The H value (the height of the portion protruding out of the upper surface of the housing 25) is about 0.8 mm. The measurement position of the H value can be referred to FIG. 3. It should be noted that, in the case that the protrusion portion 21 has the outer cover 252 and the top surface of the outer cover 252 is higher than the top surface of the top lens portion 31a, the H value indicates a distance between the top surface of the outer cover 252 and the upper surface of the upper housing 25. Conversely, in the case that the protrusion portion does not have the outer cover 252 or in the case that the top surface of the outer cover 252 is lower than the top surface of the top lens portion 31a, the H value indicates a distance between the top surface of the top lens portion 31a and the upper surface of the housing 25.

In some embodiments, the structure of the camera assembly 20 and the circuit board 16 is as shown in FIG. 9. FIG. 9 may also be regarded as a cross-sectional view showing the lens assembly 38, the optical filter 40, the image-capturing element 50, and the circuit board 16 according to some embodiments. In the embodiments shown in FIG. 9, the side surface 304 of the top lens portion 31a is not covered by the outer cover 252, and the top lens portion 31a has a cover layer covering the side surface 304 of the top lens portion 31a (which equivalents to the embodiments as shown in FIG. 4). In the embodiments shown in FIG. 9, the D value (the diameter of the top lens portion 31a plus the thickness of the cover layer) is about 1.4 to 1.6 mm. The H value of the protrusion portion 21 is about 0.8 mm. The term “module thickness” of “module thickness being between 3-5 mm” in the table below indicates the total height of the lens assembly 38, the optical filter 40, the image-capturing element 50, and the circuit board 16. In some embodiments, the module thickness may be 3.98 mm.

However, in other embodiments, the D value depends on whether the diameter of the top lens portion 31a includes the thickness of the outer cover 252 or not, and includes the thickness of the cover layer or not. The D value may range from about 1.4 to 3.5 mm. The H value may range from about 0.2 to 1.5 mm.

TABLE 1

| | |
|---|---|
| FIG. 8 | Lens: H = 0.8 mm, D = 2.2 mm |
| | Module thickness = 3-5 mm |
| FIG. 9 | Lens: H = 0.8 mm, D = 1.4 mm |
| | Module thickness = 3-5 mm |

It should be noted that the lens assemblies 38 in FIG. 8 and FIG. 9 are illustrated as cross-sectional views of a single piece. However, the internal structure of the lens assembly 38 may be substantially similar to the structure of the lens assembly 38 in FIG. 4, which may be configured to be 1G2P, 1G3P, 1G4P, etc. The lens assemblies 38 in FIG. 8 and FIG. 9 only present the schematic outline of the lens assembly 38, and are not used to show the internal structure of the lens assembly.

In summary, according to one or some embodiments, the present disclosure provides a camera assembly that can be disposed at the inner side of a display screen and provides a mobile device having the camera assembly. By utilizing the camera assembly provided in one or some embodiments of the present disclosure, the internal space of the mobile device can be effectively utilized. Furthermore, by applying the camera assembly provided in one or some embodiments of the present disclosure to a mobile device, the overall thickness of the mobile device and/or the width of the bezel of the display screen may be reduced.

What is claimed is:

1. A camera assembly, comprising:
a housing, having an opening; and
a lens assembly, disposed in the housing, wherein the lens assembly comprises:
a first lens, disposed adjacent to the opening and having a top lens portion, wherein the top lens portion protrudes out of the opening; and
a second lens, disposed at a side of the first lens opposite to the top lens portion.

2. The camera assembly according to claim 1, wherein a material of the first lens is glass, and a material of the second lens is plastic.

3. The camera assembly according to claim 2, wherein the lens assembly further comprises a third lens, and the second lens is located between the third lens and the first lens, wherein a material of the third lens is plastic.

4. The camera assembly according to claim 3, wherein the lens assembly further comprises a fourth lens, and the third lens is located between the fourth lens and the second lens, wherein a material of the fourth lens is plastic.

5. The camera assembly of claim 3, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

6. The camera assembly of claim 3, further comprising:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.

7. The camera assembly of claim 2, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

8. The camera assembly of claim 2, further comprising:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.

9. The camera assembly of claim 1, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

10. The camera assembly of claim 1, further comprising:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.

11. A mobile device, comprising:
a protective layer;
a display element adjacent to the protective layer, and the display element having a receiving trough; and
a camera assembly, comprising:
a housing, having an opening; and
a lens assembly, disposed in the housing, wherein the lens assembly comprises:
a first lens, disposed adjacent to the opening and having a top lens portion, wherein the top lens portion protrudes out of the opening and is accommodated in the receiving trough; and
a second lens, disposed at a side of the first lens opposite to the top lens portion.

12. The mobile device according to claim 11, wherein a material of the first lens is glass, and a material of the second lens is plastic.

13. The mobile device according to claim 12, wherein the lens assembly further comprises a third lens, and the second lens is located between the third lens and the first lens, wherein a material of the third lens is plastic.

14. The mobile device according to claim 13, wherein the lens assembly further comprises a fourth lens, and the third lens is located between the fourth lens and the second lens, wherein a material of the fourth lens is plastic.

15. The mobile device of claim 13, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

16. The mobile device of claim 13, wherein the camera assembly further comprises:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.

17. The mobile device of claim 12, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

18. The mobile device of claim 12, wherein the camera assembly further comprises:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.

19. The mobile device of claim 11, wherein the housing comprises an upper housing and a lower housing, and the top lens portion of the first lens outwardly protrudes from the upper housing, and wherein a side surface of the top lens portion has a cover layer, and the cover layer is a coating layer having an effect of light absorption, a coating layer having an effect of light extinction, or a coating layer having an effect of light absorption and light extinction.

20. The mobile device of claim 11, wherein the camera assembly further comprises:
an optical filter, disposed at a side of the lens assembly opposite to the opening;
an image-capturing element, wherein the optical filter is located between the lens assembly and the image-capturing element; wherein the image-capturing element is configured to receive and to convert an optical image signal incident through the lens assembly into an electrical image signal; and
a circuit board, electrically connected to the image-capturing element.
